(19) United States
(12) Patent Application Publication
(10) Pub. No.: US 2002/0168512 A1
(43) Pub. Date: Nov. 14, 2002

(54) MULTI-PLY HEAT SEALABLE LAYER AND HERMETICALLY SEALABLE PACKAGING MATERIAL PRODUCED THEREWITH

(76) Inventors: HOLGER EGGERS, WALSRODE (DE); RUDI KLEIN, WALSRODE (DE)

Correspondence Address: William C. Gerstenzang, Esq., Norris, McLaughlin & Marcus, P.A., 220 East 42nd Street - 30th Floor, New York, NY, 10017, US

(21) Appl. No.: 09/247,418

(22) Filed: Feb. 10, 1999

(30) Foreign Application Priority Data
Feb. 17, 1998 (DE) 198 06 475.6

(51) Int. Cl. B32B 27/08; B32B 15/08

(52) U.S. Cl. 428/335; 428/463; 428/514; 428/520; 428/517; 428/412; 428/331; 428/483; 428/475.8; 428/476.3

(57) ABSTRACT

The present invention relates to a multi-ply, asymmetric sequence of layers (I) usable in conjunction with a substrate as a heat sealable layer, having an outer ply (b) on the heat sealable side, wherein a melt flow rate MFR of at least 0.1 g/10 min, measured to DIN ISO 1133 AT 190° C. and 2.16 kg, is measurable for the material composition forming the overall sequence of layers (I), the sequence of layers (I) has one or more plies (i₁), (i₂) etc. of a material composition, each of which has a higher melt flow rate MFR, measured to DIN ISO 1133 at 190° C. and 2.16 kg than the material composition forming ply (b), the sum of the weights per unit area of each of the plies (i₁), (i₂) etc., is at least 40%, relative to the weight per unit area of the entire sequence of layers (I).

### BACKGROUND OF THE INVENTION

The present invention relates to a heat sealable layer comprising at least two plies of substantially thermoplastic plastics and to a packaging material containing this heat sealable layer as a constituent. The multi-ply heat sealable layer is characterised in that at least one ply of this sealing layer has a composition which, at conventional heat sealing temperatures, is of a lower viscosity than that of the ply of the heat sealable layer facing towards the product. The multi-ply heat sealable layer according to the invention is distinguished by improved heat sealing characteristics, in particular by a combination of elevated seam strength immediately after heat sealing and rapid, hermetic heat-scalability without the formation of channels in the seam. Very high processing speeds may consequently be achieved. This invention also includes packaging materials which contain such a heat sealable layer. The present invention also provides the use of the multi-ply heat sealable layer and of the packaging materials containing this layer for the production of packages and the use of these packages for packaging foodstuffs and other goods.

Many goods require protection from the ambient air or ambient atmosphere during transport and/or storage. They must accordingly be packaged in a manner which is suitable for excluding the entirety or certain components of the ambient atmosphere as completely as possible.

In many cases, such packages are produced by heat sealing one or more packaging materials to yield a package, for example a bag or lidded container. In such cases, the packaging material is firmly sealed by melting the heat sealable layer, either against itself in the case of a bag or, in the case of a lidded container, against the heat sealable layer of the other packaging material. This results in a sealed seam which seals the package. The prior art in packaging using packaging materials containing plastics is described, for example, in Ahlhaus, Verpackung mit Kunststoffen, Hanser Verlag, Munich, 1997. Specific packaging material structures are shown, for example, in Bakker, The Wiley Encyclopedia of Packaging Technology, John Wiley & Sons, New York, 1986, or for films in Nentwig, Kunststoff-Folien, HanserVerlag, Munich, 1994. These references also describe the modes of operation of typical packaging machinery.

Very severe demands are often placed upon the sealed seam. The seam must thus be capable of withstanding elevated mechanical loads from the contents, transport or other influences. In many cases, this applies immediately after heat sealing while the seam is still hot. Thus, for example, in so-called vertical form/fill/seal bagging machines, in order to save time the bag contents are introduced into the formed tube while the transverse heat sealing tool is still closed. When the sealing bars open, the entire weight of the contents bears down on the seam which has not yet cooled, so subjecting it to tensile stress. In other cases, the seam may be subjected while still hot to similar stress even without external loading solely due to the elastic resilience of the packaging material, for example when a crease or lapped portion of the packaging material is heat sealed. If the cohesion of the sealed seam is too low, the seam comes apart, so resulting in package failure. Seam strength in the hot state immediately after sealing is conventionally termed hot tack. In cases such as those described above, elevated hot tack is an important precondition for elevated packaging speeds.

The sealed seam must furthermore provide a strong seal once it has cooled again, i.e., it must be capable in this state of withstanding elevated stresses, to which the package may be subjected during storage or transport, without mechanical failure. Such strength of a sealed seam must be achieved as an additional condition for efficient, i.e., rapid and defect-free packaging operations with the shortest possible sealing times.

Moreover, it must be possible to seal the seam hermetically using the shortest possible sealing times. If channels arise between the interior and exterior of the package, the ambient atmosphere will penetrate and may thus under certain circumstances result in deterioration of the contents. The sealing of creases is particularly critical in this respect. The package may contain creases, either deliberately such as in the form of a longitudinal crease along the side of a bag or at the intersection between the longitudinal and transverse seams, or unintentionally due to poor passage through the machine, which extend into the sealed seam. If such a crease is to be hermetically sealed, the heat sealable layer must be rapidly and durably deformable during the sealing operation in order completely to fill the areas around and in the crease, such that, even in the area of the crease, there is continuous contact between the inner surfaces of the heat sealable layer or layers along the sealed seam. If excessively long sealing times are required in order to achieve a hermetic seal, this in turn reduces the processing speed of the film on the packaging machine.

The above-stated short sealing times may in particular be achieved by ensuring that the required properties, such as elevated seal strength, elevated hot tack and hermetic sealing, are achieved at low temperatures. In this manner, at a given sealing tool temperature (which in many cases is limited by the heat resistance of the support or substrate of the packaging material), it is possible in a shorter time to achieve a temperature in the seam which is sufficiently high to satisfy the stated requirements.

The provision of heat sealable layers in packaging materials according to the prior art is described below. The following considerations apply to all subsequent explanations.

Unless otherwise stated, the polymers present in the individual layers are denoted using the abbreviations for plastics to DIN 7728 or ISO 1043-1987 (E).

In multi-layer structures, the sequence of layers is described by a succession of the abbreviations of the polymers for the corresponding layers or other defined symbols, separated from each other by double oblique slashes. The heat sealable layer is always on the right. Only part of the entire sequence of layers con-stituting the structure may be stated. In these cases, the heat sealable layer is again always on the right and the unstated layers or combinations of layers are indicated by three full stops, . . . Polymers of the same type may be distinguished from each other by numbering, for example PE-LD-1//PE-LD-2//PE-LD-3. Blends of different polymers are indicated by the symbol + and by enclosing the components between brackets ( ). Details of percentage composition may optionally also be stated here. Unless otherwise stated, the proportions are always stated by weight relative to the total weight of the blend. Thus, for example, the sequence . . . //PA//EVOH// . . . //(PE-LD-1+LE-LLD)//d describes a structure having an unspecified external layer or external sequence of layers, followed by a layer substantially consisting of polyamide, followed by a layer substantially consisting of ethylene/vinyl alcohol copolymer (EVOH), followed by an unspecified layer or sequence of layers, followed by a layer comprising a blend of a low density polyethylene numbered 1 (PE-LD-1) and an ethylene/α-olefin copolymer (PE-LLD), together with a subsequent layer (d) on the sealing side to be specified in greater detail.

The melting points stated below relate to the value determined to ASTM 3418 using DSC (differential scanning calorimetry) analysis.

The melt flow rates stated below relate to the value determined to DIN ISO 1133. Measurement conditions are additionally specified with regard to temperature and applied weight, for example condition D in DIN ISO 1133 with a temperature of 190° C. and an applied weight of 2.16 kg.

The density of the raw materials relates to the measurement method in accordance with ISO 1138(A).

One method for measuring the property hot tack is stated in relation to the Examples according to the invention. In general terms, measurement is made by bringing two portions of packaging material into contact at a defined pressure and temperature for a specified time and then, while the sealed seam is still hot, peeling them apart. One parameter of particular significance here is whether and what length of delay is permitted between release of the sealing tool and application of the force. Either the maximum force which the packaging material can withstand on peeling or, given a pre-set force, the resultant deformation may be measured. A fundamental distinction must be drawn between the hot tack force as the force which the sealed seam can withstand after heat sealing without failure and the hot tack temperature as the temperature range within which a minimum level of hot tack force may be achieved under the stated sealing conditions.

The sub-stages which occur during a heat sealing operation are described by way of example in Meka & Stehling, Heat Sealing of Semicrystalline Polymer Films. II. Effect of Melting Distribution on Heat-Sealing Behaviour of Polyolefins, Journal of Applied Polymer Science, vol. 51, pp. 105-119 (1994). Initially, wetting occurs in the seam due to fusion and pressure. As the process continues, chain segments of the polymers diffuse from each side of the seam into the opposite side, so creating molecular entanglements across the seam. Once the sealing tool is removed, the seam cools and, in the case of partially crystalline materials, crystallites are also formed across the seam. If the seam is subjected to mechanical stress immediately after removal of the sealing tool, then the polymers of the seam must have sufficiently high melt strength to withstand this stress.

Using prior art heat sealable layer structures in packaging materials, it is not possible simultaneously to achieve both elevated hot tack and good channel impermeability. Channel impermeability is determined as described below under seam-permeability.

An elevated hot tack force may be achieved in heat sealable layers by selection of the polymer. Thanks to the intramolecular hydrogen bridge bonds, which are effective even at elevated temperatures, copolymers of ethylene and acrylic acid (E/AA, E/MAA) allow elevated hot tack forces and wide hot tack temperature ranges to be achieved. This applies to a still greater extent to ionomers, neutralized acid copolymers containing metal ions, due to the ionic bonding forces. The use of acid copolymers and ionomers is disadvantageous in that, at the relatively high acid contents and/or degrees of neutralization, which are ultimately responsible for the stated properties, they are themselves incompatible with polyethylene-based polymers. This makes it impossible to use the heat sealable layer for sealing with another polyethylene-based heat sealable layer, for example, in a lidded package, due to the consequently achievable low sealed seam strength. Moreover, a material from a package of this design cannot be recycled.

In the case of non-polar heat sealing media such as low and high density polyethylene (PE-LD, PE-HD), copolymers of ethylene and α-olefins (PE-LLD), copolymers of ethylene and propylene (E/P) or polypropylene (PP), experience has shown that higher hot tack is achievable at a reduced MFR, i.e., with longer chain polymers, and by lower long chain branching. In the case of PE-LLD, hot tack force may be distinctly improved with grades which are produced with metallocene catalysts, denoted mPE-LLD below, and which, in comparison with conventional grades produced using Ziegler/Natta catalysts, have a narrower molecular weight distribution and a more uniform distribution of the comonomer content along the molecule. In all cases, an increase in density brings about only a slight change in hot tack force, but the temperature range is shifted upwards.

While copolymers of ethylene and vinyl acetate (E/VA) or ethylene and unsaturated esters such as butyl acrylate or ethyl acrylate (E/BA, E/EA) do indeed achieve lower sealing temperatures as the comonomer content rises, the hot tack force also decreases.

Good channel impermeability is conventionally achieved by using polymers having a low melting point and an elevated MFR, i.e., low viscosity. In this manner, even at low sealing temperatures, the polymer of the heat sealable layer can flow into irregularly shaped sections of the seam, such as in the area of creases, so sealing them.

The requirement for elevated seal strength at short sealing times may also be achieved by purposeful selection of the polymer or polymers forming the heat sealable layer. Thus, good seam strength may also be achieved by polymers which themselves have an elevated tear strength. Such polymers are in particular copolymers of ethylene and (α-olefins (PE-LLD) at higher densities, i.e., having densities of above approx. 0.910 g/cm³. However, it is not possible using these copolymers to achieve the comparatively short sealing times as are achieved when ethylene copolymers, such as for example E/VA, E/AA, E/MAA or the like, are used. Blending the stated copolymers of ethylene and α-olefins with branched polymers such as PE-LD, improves processability while retaining approximately identical seam strength. The heat sealing activation temperature may, if required, also be shifted downwards in this manner.

If channel-free sealing of a seam is achieved under given sealing conditions, then the optimum seam strength for the given material combination is necessarily also achieved. With regard to packaging speed, the criterion of channel-free sealing at short sealing times also encompasses a requirement for an early sealing onset, i.e., achieving maximum seam strength with short sealing times. Elevated seam strength is an additional requirement to be fulfilled for channel-free sealing.

It is also prior art to blend the above-stated polymers and/or to provide a multi-layer heat sealable layer. For example, in order to optimize costs, the above-stated substances may be arranged in such a manner that the layer on the inner side of the film facing towards the product is distinguished by a particularly rapid onset of sealing and the subsequent layer used for the film core, while not melting until higher temperatures, is consequently lower in cost. Substances produced on the basis of the stated polymers, such as those modified by grafting with anhydride, may optionally also be used as coupling layers. Examples of such multi-ply structures are the sequences of layers PE-LD//E/VA or PE-LD//E/AA//ionomer.

EP 764679 A 1 describes a laminable heat sealable layer having a number of different plies, wherein, from the heat sealable side outwards, the crystallite melting point of the polymer or, in the case of polymer blends, of the blend component having the highest melt enthalpy, becomes higher in each successive layer. The advantage of this structure resides in the low sealing activation temperature simultaneously combined with elevated sealing strength. Examples of such structures are two- and three-layer composites such as PE-LLD//mPE-LLD or PE-LD//(PE-LD+PE-LLD)//(mPE-LLD+PE-LD). These films are stated to have good hot tack, but the channel impermeability of such structures is not mentioned.

Surface slip is also important for the smooth passage through machinery of packaging materials having such sealing media. According to the prior art, surface slip is improved for the stated polymers by additives. Anti-blocking agents in the form of solid particles are used for this purpose, the particles partially protruding from the outer side of the film, so reducing the effective contact area with the adjacent medium. Examples are silicon oxide, calcium carbonate, magnesium silicate, aluminium silicate, calcium phosphate, talcum and the like. Of these, silicon dioxide is preferably used. Effective quantities are within the range from 0.1 to 2 wt. %. Average particle size is between 1 and 10 μm, wherein particles of a spherical form are particularly suitable. In multi-layer structures, these particles are preferably used only in the outer layer.

Other additives which improve the surface slip of the film, also in conjunction with the stated solid particles, are the higher aliphatic acid amides, higher aliphatic acid esters, waxes, metal soaps and polydimethylsiloxanes conventionally known as lubricants. The effective quantity of lubricant is within the range from 0.01 to 3 wt. %, preferably from 0.02 to 1 wt. %. One aliphatic acid amide conventionally used for polyolefins is erucamide. The stated materials can only be absorbed into the polymer to a limited extent and are thus deposited on the surfaces after processing. In this manner, a film having good surface slip is formed.

In summary, the heat sealable layer should have elevated melt strength in order to achieve good hot tack and a low melt strength in order to achieve good channel impermeability. It is not possible to achieve both objectives with known prior art single or multi-layer heat sealable layers. Packaging speeds on typical packaging plant, such as horizontal and in particular vertical form/fill/seal bagging machines are thus in many cases limited either by inadequate hot tack or excessively low channel impermeability.

The object thus arose of providing a sealing medium for packaging materials which allows both elevated hot tack and a hermetic seal to be achieved at short sealing times and consequently, in conjunction with a packaging material containing this sealing medium, permits higher packing speeds. The heat sealable layer should furthermore have adequate seam strength and, for the purposes of combination with another heat sealable layer in a package and for material recycling of the package, should be compatible with conventional polyolefin heat sealing media and thus be heat-sealable and miscible with polyethylene.

This has been achieved according to the invention by providing a multi-plied laminate (I) having an asymmetric structure comprising an outer ply (b), and at least one inner ply (i) wherein melt flow rate as determined in accordance with DIN ISO 1133 at 190° C. and 2.16 kg (MFR) of (I) is at least 0.1 g/10 min., and wherein MFR of (b) is at least 0.1 g/10 min. The laminate is further characterized in that the weight per area of (i) is at least 40% of the weight per area of said (I).The outer ply comprise a first polymeric resin and the inner ply comprise a second, different, polymeric resin.

The sequence of layers (I) according to the invention preferably contains polymers or blends of polymers from the group comprising copolymers of ethylene and vinyl acetate (E/VA), particularly preferably having a vinyl acetate content, relative to the total weight of the polymer, of at most 20%, copolymers of ethylene and unsaturated esters such as butyl acrylate or ethyl acrylate (E/BA and E/EA respectively), copolymers of ethylene and unsaturated carboxylic acids (E/AA, E/MAA), particularly preferably having a content of the carboxylic acid comonomer, relative to the total weight of the polymer, of at most 15%, still more preferably of at most 8%, salts of the copolymers of ethylene and unsaturated carboxylic acids, in particular E/MAA (ionomers), particularly preferably having a content of the carboxylic acid comonomer, relative to the total weight of the ionomer, of at most 15%, still more preferably of at most 10%, low density polyethylene (PE-LD), particularly preferably of a density of at least 0.91 g/cm³ and at most 0.935 g/cm³, high density polyethylene (PD-HD), copolymers (PE-LLD) of ethylene and α-olefins having at least 3 C atoms, preferably butene, hexene, octene, 4-methyl-1-pentene. The copolymers (PE-LLD) of ethylene and α-olefins may be produced with conventional catalysts or with metallocene catalysts. Of these, copolymers (PE-LLD) of ethylene and α-olefins having a density of at least 0.90 g/cm³ and at most 0.94 g/cm³ are particularly preferred.

Of the stated polymers, ply (b) preferably contains copolymers (PE-LLD) of ethylene and α-olefins, low density polyethylene (PE-LD) and copolymers of ethylene and vinyl acetate (E/VA). Relative to the total weight of ply (b), a content of 50% to 100% of PE-LLD is particularly preferred. In a preferred embodiment thereof, the PE-LLD used is produced with metallocene catalysts and is distinguished by a crystallite melting point of at most 110° C. and a ratio of the weight and number average molecular weights (M_{W}/M_{N}) of at most 3.

The polymers used in the sequence of layers (I) preferably have a melt flow rate, measured to DIN ISO 1133 at 190° C. and an applied weight of 2.16 kg, of at least 0.1 g/10 min and at most 15 g/10 min, particularly preferably of at least 0.5 g/10 min and at most 8 g/10 min. In this manner, ply (b) of the multi-ply sequence of layers (I) according to the invention contains a composition with a melt flow rate, measured at 190° C. and an applied weight of 2.16 kg, of at least 0.1 g/10 min and at most 3 g/ 10 min, particularly preferably of at least 0.5 g/10 min and at most 2 g/10 min, plies (i₁, i₂, etc.) are each of a composition with a melt flow rate, measured at 190° C. and an applied weight of 2.16 kg, of at least twice, preferably at least three times and still more preferably at four times the melt flow rate of the composition forming ply (b).

The sum of the weights per unit area of each ply (i₁), (i₂), etc., the material composition of which has a higher melt flow rate MFR, measured to DIN ISO 1133 at 190° C. and 2.16 kg, than the outer ply (b) on the heat sealable side, amounts, relative to the weight per unit area of the entire sequence of layers (I), preferably to at least 60%, in a still more preferred embodiment to at least 70%.

Ply (b) of the multi-ply sequence of layers (I) according to the invention preferably has a thickness of at most 50 μm, still more suitably of at most 30 μm and in a still more preferred embodiment of at most 20 μm . Thicknesses of ply (b) of at least 5 μm, preferably of at least 10 μm, are preferred.

The multi-layer sequence of layers (I) according to the invention preferably has no further plies other than the ply (b) and the plies (i₁, i₂, etc.). Particularly preferably, (I) has the structure (i₂)//(i₂)//(b), more particularly preferably the structure (i₁)//(b).

One embodiment of the sequence of layers (I) which is in particular possible is the structure (i₁)//(b), wherein plies (i₁) and (b) differ substantially only with regard to melt flow rate.

All the or individual plies of the sequence of layers (I) may additionally be provided with additives which improve the functionality of the film. Examples are solid inorganic particles known as anti-blocking agents, which protrude from the outer surface of the heat sealable layer and thus improve the surface slip behaviour of the film. Silicon oxide, calcium carbonate, magnesium silicate, aluminiurn silicate, calcium phosphate, talcum and the like are suitable for this purpose. Of these, silicon dioxide is preferably used. Effective quantities are in the range from 0.1 to 2 wt. %, preferably from 0.1 to 0.8 wt. %. Average particle size is between 1 and 20 μm , preferably between 2 and 15 μm, wherein particles of a spherical form are particularly suitable. These particles are preferably used only in ply (b).

Other additives which improve the surface slip of the film, also in conjunction with the stated solid particles, are the higher aliphatic acid amides, higher aliphatic acid esters, waxes, metal soaps and polydimethylsiloxanes conventionally known as lubricants. The effective quantity of lubricant is within the range from 0.01 to 3 wt. %, preferably from 0.02 to 1 wt. %. Addition of higher aliphatic acid amides in the range from 0.01 to 0.25 wt. % is particularly suitable. One aliphatic acid amide particularly suitable for the above-stated polymers used in the sequence of layers (I) is erucamide.

The sequence of layers (I) according to the invention may be colored by the addition of dyes.

By means of the multi-ply heat sealable layer according to the invention, it is possible to provide a sealing medium which may be incorporated into a composite packaging material, which medium is distinguished not only by good hot tack, but surprisingly additionally by elevated channel impermeability. A packaging material containing this heat sealable layer permits unexpectedly high packaging speeds on packaging machines of a conventional design with a low rate of leaky or defectively sealed packages.

The present invention accordingly also provides a packaging material containing the multi-ply heat sealable layer according to the invention and the use of the packaging material for packaging foodstuffs and the like, medical products and any type of products which are packaged in a modified atmosphere or undergo spoilage in the presence of moisture and/or oxygen.

Production Process

The heat sealable layer according to the invention and the packaging material containing it may be produced on conventional plant for the production of multi-layer composites. The packaging material containing this heat sealable layer may in particular be a composite film having a substrate of paper, aluminium, cellulose film, polypropylene, polyalkylene terephthalate, polyamide, polycarbonate, polyvinyl alcohol, EVOH, polystyrene or combinations thereof, wherein the thermoplastics may be oriented or unoriented.

If the packaging film is a plastic film, there is the possibility of coextruding all or some of the layers of the film together as a blown or flat film, i.e., bringing together the polymers of these layers as molten streams and allowing them to flow in molten form through a common die. Both the multi-ply heat sealable layer according to the invention and a composite film according to the invention containing this multi-ply heat sealable layer as a constituent may be produced in this manner.

The multi-ply heat sealable layer according to the invention may also be applied by extrusion coating, i.e., by application of the heat sealable layer in a molten state onto a previously produced support web, so forming with the support web the packaging material according to the invention. In such cases, the support web may consist of plastics, such as, for example, the above-stated polymers, metals, cardboard, paper, paperboard, textiles, non-wovens, woven fabrics or composites of the stated materials.

The multi-ply heat sealable layer according to the invention may also be produced by extrusion lamination, i.e., by application of one or more molten thermoplastic polymer layers between two sequences of layers of the packaging material according to the invention. The layers introduced as a melt into the composite may here form part of the multi-ply heat sealable layer according to the invention. In this process, the sequence of layers fed onto the heat sealable side is either a part or the entirety of the multi-ply heat sealable layer according to the invention. The web fed onto the other side may consist of plastics, such as, for example, the above-stated polymers, metals, cardboard, paper, paperboard, textiles, non-wovens, woven fabrics or composites of the stated materials.

If the support web and the multi-ply heat sealable layer according to the invention are produced separately, they may also be bonded together to yield the packaging material according to the invention by using a laminating adhesive. In this case, the multi-ply heat sealable layer may again have been produced as a blown or flat film and the support web may consist of plastics, such as, for example, the above-stated polymers, metals, cardboard, paper, paperboard, textiles, non-wovens, woven fabrics or composites of the stated materials.

The multi-ply heat sealable layer according to the invention may also be subjected to an orienting operation after extrusion. Orientation may be performed only in the longitudinal direction, only in the transverse direction, first in the longitudinal and then in the transverse direction, simultaneously in the longitudinal and transverse directions or in combinations of these stages. Orientation may here be performed on the multi-ply heat sealable layer alone or on the packaging material containing it.

The invention is further illustrated but is not intended to be limited by the following examples in which all parts and percentages are by weight unless otherwise specified.

### EXAMPLES

### Test series 1, Example 1.1

A heat sealable layer having the structure PE-LD-1//(80% PE-LLD+20% PE-LD-2) with layer thicknesses 40 μm//20 μm was produced as a blown film by coextrusion and, using a laminating adhesive, laminated against a conventional commercial biaxially oriented polyamide of a thickness of 15 μm.

PE-LD-1 has a density of 0.918 g/cm³, a melting point of 106° C. and an MFR of 3.7 g/10 min at 190° C. and 2.16 kg. PE-LD-2 has a density of 0.923 g/cm³, a melting point of 108° C. and an MFR of 2 g/10 min at 190° C. and 2.16 kg and is combined with 500 ppm of erucamide and 1000 ppm of silicon oxide of an average particle size of 15 μm. PE-LLD is an ethylene-octene copolymer having a density of 0.920 g/cm³, a melting point of 124° C. and an MFR of 1.1 g/10 min at 190° C. and 2.16 kg.

### Test series 1, Example 1.2

Laminate from Example 1.1, wherein the sealing layer has the structure PE-LD-3//(80% PE-LLD+20% PE-LD-2) with layer thicknesses 40 μm//20 μm and was produced as in Example 1.1. The difference from Example 1.1 is between PE-LD-1 and PE-LD-3, wherein PE-LD-3 has a density of 0.915 g/cm³, a melting point of 104° C. and an MFR of 8 g/10 min at 190° C. and 2.16 kg.

### Test Series 1, Comparative Example 1.3

Laminate from Example 1.1, wherein the sealing layer has the structure PE-LD-4//(80% PE-LLD+20% PE-LD-2) with layer thicknesses 40 μm//20 μm and was produced as in Example 1.1. The difference from Example 1.1 is between PE-LD-1 and PE-LD-4, wherein PE-LD-4 has a density of 0.923 g/cm³, a melting point of 111° C. and an MFR of 0.9 g/10 min at 190° C. and 2.16kg.

### Test Series 2. Example 2.1

Laminate as in Example 1.1, wherein the heat sealable layer has the structure E/VA-1//E-VA-2 in thicknesses of 35 μm//15 μm. Both E/VA copolymers have a vinyl acetate content of 5.0%, a density of 0.925 g/cm³ and a melting point of 101° C. At 190° C. and 2.16 kg, E/VA-1 has an MFR of 8 g/10 min and E/VA-2 an MFR of 2 g/10 min.

### Test series 2. Comparative Example 2.2

Laminate as in Example 1.1, wherein the heat sealable layer is a single ply structure E/VA-2 of a thickness of 50 μm. E/VA-2 corresponds to the polymer of the same name from Example 2.1.

### Test Series 2. Comparative Example 2.3

Laminate as in Example 2.1, wherein the heat sealable layer has the structure E/VA-2//E-VA-1 in thicknesses of 15 μm//35 μm. Both E/VA copolymers have a vinyl acetate content of 5.0%, a density of 0.925 g/cm³ and a melting point of 101° C. At 190° C. and 2.16 kg, E/VA-1 has an MFR of 8 g/10 min and E/VA-2 an MFR of 2 g/10 min.

### Test Series 3. Example 3.1

Laminate as in Example 1.1, wherein the heat sealable layer has the structure PE-LD-5//E/VA-1//(60% mPE-LLD+40% PE-LD-6) in thicknesses of 10 μm//30 μm//10 μm. PE-LD-5 has a density of 0.922 g/cm³, a melting point of 109° C. and an MFR of 0.3 g/10 min at 190° C. and 2.16 kg, PE-LD-6 has a density of 0.919 g/cm³, a melting point of 105° C. and an MFR of 0.3 g/10 min at 190° C. and 2.16 kg, mPE-LLD has a density of 0.902 g/cm³, a melting point of 100° C. and an MFR of 1 g/10 min at 190° C. and 2.16 kg. mPE-LLD is produced with a metallocene catalyst. E/VA-1 corresponds to the polymer of the same name from Example 2.1.

### Test Series 3. Comparative Example 3.2

Laminate from Example 1.1, wherein the heat sealable layer has the structure (60% mPE-LLD+40% PE-LD-6) with a thickness of 50 μm and was produced as in Example 1.1. Polymers mPE-LLD and PE-LD-6 correspond to the grades of the same name from Example 3.1.

The following characteristics were measured as follows on the films according to the invention stated by way of example and on the Comparative Examples:

Seal strength

Two defect-free, clean sample strips are taken from the film web to be tested. They are heat sealed by laying the surfaces to heat sealed against each other and fixing them between the sealing bars in such an manner that the sample protrudes by at least 1 cm on each side. Sealing is performed perpendicularly relative to the machine direction of the film. The sealing bars are smooth and heated on both sides to the nominal heat sealing temperature. Heat sealing proceeds under standard conditions of 0.5 seconds and a pressure of 50 N/cm². Comparative measurements for shorter sealing times were also performed by way of example. In the following tables, data stated without specifying a sealing time always relate to a sealing time of 0.5 s. Any deviations from these test conditions are stated. A test strip of 15 mm in width is cut from the resultant seam after cooling and tested on a tensile tester at a speed of 100 mm/min and a clamping distance of 20 mm. Sealing strength is recorded as the maximum force required to separate the sealed films.

Hot tack force

Test strips of approx. 90 mm in length and 45 mm in width are taken in machine direction and are clamped with the sides to be sealed against each other in the sample holder. Heat sealing is performed under the same conditions with regard to the sealing tool, pressure and times as for seal strength, i.e., over an area 20 mm in width. Immediately upon completion of the sealing test, the strength of the hot sealed seam is tested at a testing speed of 25 m/min. The force profile is measured electronically and recorded on a PC. The maximum force is read off from a graphical representation of the force profile.

Seam impermeability

A 20×20 cm sheet of the material is cut out and the sides to be sealed laid together along one edge. This edge is then heat sealed in the manner described in “seam strength” and the resultant seam denoted the “longitudinal seam”. The resultant tube, with the longitudinal seam flattened, is then heat sealed in the same manner along one of the sides which are still open. The flattened longitudinal seam here forms a crease. Methanol colored with methylene blue is introduced to a depth of approx. 5 mm into the gap between the longitudinal and transverse seams of the resultant half pouch. Any channels in the seam are revealed by the methylene blue solution passing through them. It is noted whether any leaks occur or whether the transverse seam is impermeably sealed across its entire width.

The following tables summarize the results:

| | | Example or Comparative Example | | |
|---|---|---|---|---|
| | | Example | Example | Comparison |
| Feature | Unit | 1.1 | 1.2 | 1.3 |
| Seal strength at | N/15 mm | 0.5 | 0.6 | 0.5 |
| 100° C. | | | | |
| Seal strength at | N/15 mm | 5.4 | 4.6 | 5.2 |
| 110° C. | | | | |
| Seal strength at | N/15 mm | 39.2 | 40.7 | 43.6 |
| 120° C. | | | | |
| Seal strength at | N/15 mm | 45.4 | 44.8 | 46.0 |
| 130° C. | | | | |
| Max. hot tack force at | N/45 mm | 4.2 | 5.1 | 4.9 |
| 100° C. | | | | |
| Max. hot tack force at | N/45 mm | 21.6 | 22.5 | 23.1 |
| 110° C. | | | | |
| Max. hot tack force at | N/45 mm | 47.0 | 45.9 | 50.1 |
| 120° C. | | | | |
| Max. hot tack force at | N/45 mm | 35.1 | 32.8 | 37.6 |
| 130° C. | | | | |
| Channels in bag on | yes/no | yes | yes | yes |
| sealing at 100° C. | | | | |
| Channels in bag on | yes/no | yes | no | yes |
| sealing at 110° C. | | | | |
| Channels in bag on | yes/no | no | no | yes |
| sealing at 115° C. | | | | |
| Channels in bag on | yes/no | no | no | yes |
| sealing at 120° C. | | | | |
| Channels in bag on | yes/no | no | no | yes |
| sealing at 130° C. | | | | |

Characteristics of films according to the invention and comparison
specimens, Test series 1.

| | | Example or Comparative Example | | |
|---|---|---|---|---|
| | | Example | Comp. | Comparison |
| Feature | Unit | 2.1 | 2.2 | 2.3 |
| Seal strength at 90° C. | N/15 mm | 0.7 | 0.3 | 0.5 |
| Seal strength at 100° C. | N/15 mm | 25.3 | 23.9 | 24.6 |
| Seal strength at 110° C. | N/15 mm | 33.8 | 32.0 | 34.7 |
| Seal strength at 120° C. | N/15 mm | 34.2 | 35.7 | 33.2 |
| Max. hot tack force at | N/45 mm | 4.1 | 3.4 | 2.2 |
| 90° C. | | | | |
| Max. hot tack force at | N/45 mm | 9.7 | 10.5 | 2.9 |
| 100° C. | | | | |
| Max. hot tack force at | N/45 mm | 7.5 | 8.3 | 2.5 |
| 110° C. | | | | |
| Max. hot tack force at | N/45 mm | 6.0 | 7.5 | 1.9 |
| 120° C. | | | | |
| Channels in bag on | yes/no | yes | yes | yes |
| sealing at 90° C. | | | | |
| Channels in bag on | yes/no | yes | yes | yes |
| sealing at 100° C. | | | | |
| Channels in bag on | yes/no | no | yes | no |
| sealing at 110° C. | | | | |
| Channels in bag on | yes/no | no | yes | no |
| sealing at 120° C. | | | | |

Characteristics of films according to the invention and comparison
specimens, Test series 2.

| | | Example or | |
|---|---|---|---|
| | | Comparative Example | |
| | | Example | Comparison |
| Feature | Unit | 3.1 | 1.3 |
| Seal strength at 80° C. | N/15 mm | 0.4 | 0.6 |
| Seal strength at 90° C. | N/15 mm | 10.8 | 11.2 |
| Seal strength at 100° C. | N/15 mm | 44.0 | 46.2 |
| Seal strength at 110° C. | N/15 mm | 46.9 | 49.8 |
| Seal strength at 120° C. | N/15 mm | 50.3 | 58.1 |
| Max. hot tack force at 80° C. | N/45 mm | 4.5 | 3.4 |
| Max. hot tack force at 90° C. | N/45 mm | 25.4 | 23.1 |
| Max. hot tack force at 100° C. | N/45 mm | 29.8 | 30.5 |
| Max. hot tack force at 110° C. | N/45 mm | 27.2 | 34.5 |
| Max. hot tack force at 120° C. | N/45 mm | 24.0 | 19.9 |
| Channels in bag on sealing at | yes/no | yes | yes |
| 90° C. | | | |
| Channels in bag on sealing at | yes/no | yes | yes |
| 100° C. | | | |
| Channels in bag on sealing at | yes/no | no | yes |
| 110° C. | | | |
| Channels in bag on sealing at | yes/no | no | yes |
| 120° C. | | | |
| Seal strength at 120° C., sealing | N/15 mm | 47.2 | 48.8 |
| time = 0.25 s | | | |
| Max. hot tack force at 120° C., | N/45 mm | 28.3 | 29.6 |
| sealing time = 0.25 s | | | |
| Channels on sealing at 120° C., | yes/no | no | yes |
| sealing time = 0.25 s | | | |

Characteristics of films according to the invention and comparison specimens, Test series 3.

The required hermetic sealing is thus achieved by the heat sealable layer according to the invention in the embodiments stated by way of example at sealing temperatures distinctly lower than with comparable prior art grades. There is no accompanying degradation of hot tack and seal strength. The absence of channels achieved at lower temperatures also means, however, that this may be achieved at an identical sealing temperature and a shorter sealing time. This situation has been verified by way of example for test series 3.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A multi-plied laminate (I) having an asymmetric structure comprising an outer ply (b), and at least one inner ply (i) wherein melt flow rate as determined in accordance with DIN ISO 1133 at 190° C. and 2.16 kg (MFR) of said (b) is at least 0.1 g/10 min., and wherein MFR of said (i) is greater than said MFR of said (b), said laminate characterized in that the weight per area of said (i) is at least 40% of the weight per area of said (I), said outer ply comprising a first polymeric resin and said inner ply comprising a second polymeric resin.

2. The multi-plied laminate of claim 1 wherein MFR of said (b) is 0.1 to 3 g/10 min.

3. The multi-plied laminate of claim 1 wherein MFR of said (b) is 0.5 to 2 g/10 min.

4. The multi-plied laminate of claim 1 wherein MFR of said (i) is at least twice the MFR of said (b).

5. The multi-plied laminate of claim 1 wherein MFR of said (i) is at least thrice the MFR of said (b).

6. The multi-plied laminate of claim 1 wherein weight per area of said (i) is at least 60% of the weight per area of said (I).

7. The multi-plied laminate of claim 1 wherein weight per area of said (i) is at least 70% of the weight per area of said (I).

8. The multi-plied laminate of claim 1 wherein (b) has a thickness of 5 to 50 μm.

9. The multi-plied laminate of claim 1 wherein (b) has a thickness of 10 to 30 μm.

10. The multi-plied laminate of claim 1 wherein (b) has a thickness of 10 to 20 μm.

11. The multi-plied laminate of claim 1 wherein structure consists of an outer ply (b) and at least one inner ply (i).

12. The multi-plied laminate of claim 1 wherein said inner ply (i) includes two plies.

13. The multi-plied laminate of claim 1 wherein said first polymeric resin comprises at least one member selected from the group consisting of ethylene/vinyl acetate copolymer, ethylene/unsaturated ester copolymer, ethylene/unsaturated carboxylic acid copolymer, salt of ethylene/unsaturated carboxylic acid copolymer, low density polyethylene, high density polyethylene, copolymer of ethylene and α-olefin having at least 3 carbon atoms.

14. The multi-plied laminate of claim 13 wherein said unsaturated ester comprises at least one member selected from the group consisting of butyl acrylate and ethyl acrylate.

15. The multi-plied laminate of claim 13 wherein α-olefin of said copolymer of ethylene comprises at least one member selected from the group consisting of butene, hexene, octene and 4-methyl-1-pentene.

16. The multi-plied laminate of claim 15 wherein copolymer comprises the product of a reaction catalyzed by metallocene.

17. The multi-plied laminate of claim 1 wherein said second polymeric resin comprises at least one member selected from the group consisting of ethylene/vinyl acetate copolymer, ethylene/unsaturated ester copolymer, ethylene/unsaturated carboxylic acid copolymer, salt of ethylene/unsaturated carboxylic acid copolymer, low density polyethylene, high density polyethylene, copolymer of ethylene and α-olefin having at least 3 carbon atoms.

18. The multi-plied laminate of claim 1 wherein said first polymeric resin comprises at least one member selected from the group consisting of ethylene/vinyl acetate copolymer wherein content of vinyl acetate is at most 20% relative to the weight of said copolymer, ethylene/unsaturated carboxylic acid copolymer wherein content of carboxylic acid is at most 8% relative to the weight of said copolymer, salt of ethylene/unsaturated carboxylic acid copolymer having a content of carboxylic acid of at most 10% relative to the weight of said copolymer, low density polyethylene having a density of 0.91 to 0.935 g/cm3, copolymer of ethylene and α-olefin having density of 0.90 to 0.94 g/cm3.

19. The multi-plied laminate of claim 1 wherein said second polymeric resin comprises at least one member selected from the group consisting of ethylene/vinyl acetate copolymer wherein content of vinyl acetate is at most 20% relative to the weight of said copolymer, ethylene/unsaturated carboxylic acid copolymer wherein content of carboxylic acid is at most 8% relative to the weight of said copolymer, salt of ethylene/unsaturated carboxylic acid copolymer having a content of carboxylic acid of at most 10% relative to the weight of said copolymer, low density polyethylene having a density of 0.91 to 0.935 g/cm3, copolymer of ethylene and α-olefin having density of 0.90 to 0.94 g/cm3.

20. The multi-plied laminate of claim 1 wherein said (b) comprises a copolymer of ethylene and α-olefin.

21. The multi-plied laminate of claim 20 wherein said copolymer further comprises at least one member selected from the group consisting of low density polyethylene, copolymer of ethylene and vinyl acetate, said member being present in an amount of up to 50% relative to the total weight of said ply (b).

22. The multi-plied laminate of claim 21 wherein said copolymer of ethylene and α-olefin is characterized in that it is a product of a reaction catalyzed by metallocene, and in that it has a crystalline melting point of at most 110° C., and in that its ratio of weight average molecular weight to number average molecular weight is at most 3.

23. The multi-plied laminate of claim 1 wherein a least one of said (i) and said (b) include anti-blocking additives and/or dyes.

24. The multi-plied laminate of claim 1 wherein said (b) comprises about 0.1 to 2% relative to the weight of said (b) of solid inorganic particles selected from the group consisting of silicon oxide, calcium carbonate, magnesium silicate, aluminum silicate, calcium phosphate and talc.

25. A composite film comprising the laminate of claim 1.

26. The composite film of claim 25 further comprising a substrate selected from the group consisting of metal, cardboard, paper, paperboard, textile, non-woven fabric, woven fabric plastic and composites thereof, said plastic being other than said first polymer resin and said second polymer resin.

27. The composite film of claim 26 wherein said substrate is at least one member selected from the group consisting of paper, aluminum, cellulose, polypropylene, polyalkylene terephthalate, polyamide, polycarbonate, polyvinyl alcohol, EVOH, polystyrene.

28. The composite film of claim 26 wherein substrate is in oriented form.

29. The composite film of claim 26 wherein substrate is in unoriented form.

30. A composite film comprising the laminate of claim 1 as heat sealable layer with said ply (b) being one outer layer of said laminate.
